(19) United States
(12) Patent Application Publication
(10) Pub. No.: US 2020/0153001 A1
(43) Pub. Date: May 14, 2020

(54) BONDING IN ELECTROCHEMICAL CELLS, AND STACKING OF ELECTROCHEMICAL CELLS

(71) Applicant: TESA SE, Norderstedt (DE)

(72) Inventors: Klaus KEITE-TELGENBÜSCHER, Hamburg (DE); Christoph TZSCHOCH, Wolfsburg/Fallersleben (DE)

(73) Assignee: TESA SE, Norderstedt (DE)

(21) Appl. No.: 16/604,389

(22) PCT Filed: Mar. 29, 2018
(86) PCT No.: PCT/EP2018/058160

§ 371 Date: Oct. 10, 2019

(30) Foreign Application Priority Data
Apr. 10, 2017 (DE) 10 2017 206 083.2

(51) Int. Cl. H01M 8/0297; C25B 9/18; C09J 7/38; C09J 153/02; C09J 201/02; H01M 8/0221; H01M 8/0228; H01M 8/0284

(52) U.S. Cl. CPC H01M 8/0297; C25B 9/18; C09J 7/38; C09J 153/02; H01M 2008/1095; H01M 8/0221; H01M 8/0228; H01M 8/0284; C09J 201/02

(57) ABSTRACT

Disclosed is an electrochemical cell or a stack of at least two electrochemical cells, wherein at least two components of the electrochemical cell or of the stack of electrochemical cells are bonded together by means of a strip of adhesive which can be removed again, in particular without residue or destruction, by stretching substantially in the bonding plane, wherein the strip of adhesive comprises one or more adhesive material layers and optionally one or more carrier layers, and wherein the outer upper surface and the outer lower surface of the strip of adhesive are formed by the one or more adhesive material layers. Also disclosed is the use of a strip of adhesive of this kind for bonding together components in an electrochemical cell or in a stack of at least two electrochemical cells.

This application is a § 371 national stage of PCT International Application No. PCT/EP2018/058160, filed Mar. 29, 2018, which claims foreign priority benefit under 35 U.S.C. § 119 of German Patent Application No. 10 2017 206 083.2, filed Apr. 10, 2017, the disclosures of each of which are incorporated herein by reference.

The present invention relates to the bonding of components in an electrochemical cell or in a “stack” of electrochemical cells, the bonding taking place using an adhesive strip in each case.

Stacks of electrochemical cells, such as more particularly fuel cell stacks, are presently compressed by means of massive mechanical tightening devices in order to produce media imperviosity in the individual cells. For this sealing it is common to use silicone seals. These silicone seals and the mechanical tightening are to be replaced by adhesive bonding of the individual layers of the stack, with the bond taking over not only the mechanical joining but also the sealing of the cells.

A disadvantage of the bonding is the difficulty of disassembling the stack in order to replace individual defective elements. Such disassembly is generally impossible without destruction of individual layers. Reassembly as well is costly and inconvenient, owing to remaining artefacts and residues of adhesive, and entails a risk of lack of sealing.

The problems affect, in particular, fuel cells with solid electrolyte membrane, especially those with polymer electrolyte membrane. Beyond the sector of the fuel cells, however, they also affect other kinds of electrochemical cells, such as electrolysis cells with solid electrolyte membrane. There is a substantial focus here on low-temperature cells (about <120° C.).

Among the various types of fuel cells, the low operating temperature (around 20° C. to 120° C.) and the stable electrolyte favor—for the low and medium load segment—the LT PEM fuel cell (low-temperature proton exchange membrane or polymer electrolyte membrane (PEM)). The costly and inconvenient manufacture of these fuel cells, however, has to date limited their possible deployment in large numbers.

As part of the Fuel Cell Bond research project (IGF 17062 N), a bonding technology was developed for bipolar plates composed of graphite-polypropylene-carbon black compound and stainless steel. In this case, the number of handling units in the assembly of the stacks was reduced from an existing three to one and the system achieved both electrical conductivity and imperviosity to hydrogen. Adhesives used were pressure sensitive acrylate adhesives, hotmelt adhesives, and also reactive silicone and epoxy adhesives. Highly elastically or plastically extensible adhesive tapes which are redetachable by extensive stretching in the bond plane, also called strippable adhesive tapes, were not used, however.

Pressure sensitive adhesives, also called PSAs, have been known for a long time. PSAs are those adhesives which permit a durable bond to the substrate even under relatively weak applied pressure, and which, after use, can be redetached from the substrate substantially without residue. PSAs are permanently adhesive at room temperature, thus having a sufficiently low viscosity and a high tack, so that they wet the surface of the respective bonding base even under low applied pressure. The bondability of the adhesives and the redetachability derive from their adhesive properties and from their cohesive properties. A variety of compounds make a suitable basis for PSAs. Adhesive tapes furnished with PSAs, referred to as pressure sensitive adhesive tapes, are nowadays in diverse use in the industrial and domestic spheres. Pressure sensitive adhesive tapes consist customarily of a carrier film furnished on one or both sides with a PSA. There are also pressure sensitive adhesive tapes which consist exclusively of a layer of PSA, with no carrier film—the so-called transfer tapes. The composition of the pressure sensitive adhesive tapes may differ greatly and is guided by the respective requirements of the various applications. The carriers consist typically of polymeric films such as polypropylene, polyethylene or polyester, for example, or else of paper or woven or nonwoven fabric. For strippable pressure sensitive adhesive tapes, elastic carriers are preferably used.

In a further Fuel Cell Fully Bonded project (IGF 18948N), further adhesive bonds in the stack are being developed with similar adhesives. Within this project, research is being conducted into the optimization of individual fuel cells and also of stack production. The active-side bonding of the graphitic bipolar plate (BPP) to the catalytic membrane-electrode assembly (MEA) enables a fully automated manufacturing operation for a fuel cell stack. For this purpose, the bipolar plate and the MEA are being optimized both geometrically and surface-energetically for the deployment of adhesive technology. The surface of the MEA, with its Teflonized structure, carries a challenge for adhesive technology. Both one-component thermosetting epoxy resin adhesives and polyolefins are being developed and tested for use in the joining of BPP to MEA. For that purpose they are required to satisfy the mechanical and chemical demands which occur within the fuel cell. As well as this primary bonding, all of the other sealing and contacting scenarios, deriving from the applied pressure, must be realized by adhesive technology. Here as well, however, there is no use of strippable pressure sensitive adhesive tapes.

Adhesive tapes for the sealing connection of elements in fuel cell stacks have also already been disclosed in the patent literature.

Thus DE 10 2005 046 461 A1 discloses a fuel cell arrangement comprising at least one bipolar plate layer and a bond partner, the bond partner being adhered to the bipolar plate layer with a physically setting adhesive or with a pressure sensitive adhesive located on a three-dimensional sealing structure of the bipolar plate layer and/or on adjacent marginal regions of the bipolar plate layer. The primary property of a seal, namely elasticity with tolerance compensation, is taken on in this case, however, by the three-dimensional sealing structure, rather than being achieved by virtue of the bonding itself. The elasticity particularly will not be able to be achieved by the pressure sensitive adhesives, and so a corresponding three-dimensional sealing structure having elastic properties is required for tolerance compensation. The pressure sensitive adhesive, moreover, is expressly not provided in the form of an adhesive tape.

DE 10 2009 014 872 A1 discloses pressure sensitive adhesive tapes which have not only a high peel adhesion but also a high creep relaxation factor according to DIN EN 13555. For this purpose, corresponding PSAs are selected from the groups of acrylate PSAs, synthetic rubber PSAs or silicone PSAs. The creep relaxation factor provides information on the compressive loading resistance of the adhesive tape when employed as a pressure-loaded sealing element. This relates to the conventional construction of, i.e., cohesion in, electrochemical cell stacks, and is of little relevance to the bonded construction, where the compressive loading is not present to the same degree.

EP 2 096 701 A2 discloses an aftercuring sealing tape made of noncrosslinked rubber which accommodates the MEA and bonds it between the frames encasing the membrane. The rubber is subsequently crosslinked and in that way the bond is produced. Rubbers used are preferably ethylene-propylene rubber (EPM), ethylene-propylene-diene rubber (EPDM), acrylonitrile-butadiene rubber (NBR), and hydrogenated acrylonitrile-butadiene rubber (H-NBR), which are crosslinked with peroxide and which have an adhesion-boosting component made up of resorcinol resin, a melamine resin, and a silane. The adhesion-boosting components are present in a small proportion, and so the sealing tape does not have pressure sensitive adhesive properties. After crosslinking, the crosslinked rubber likewise does not have any pressure sensitive adhesive properties.

Starting out from the prior art, then, the problem addressed by the present invention is that of bonding components of an electrochemical cell or of a stack of electrochemical cells to one another in such a way that the later reversal of the bonding can be carried out more easily and therefore the later replacement of defective components or units, i.e., component assemblies, can be facilitated. The bond is typically also intended to reduce the imperviosity risk on reassembly of the electrochemical cell or stack of electrochemical cells, respectively.

The problem is solved by an electrochemical cell or a stack of at least two electrochemical cells disclosed herein, i.e., by an electrochemical cell or a stack of at least two electrochemical cells, wherein at least two components are bonded to one another by means of an adhesive strip which is redetachable by extensive stretching substantially in the bond plane, i.e., which is strippable, the adhesive strip comprising one or more layers of pressure sensitive adhesive and optionally one or more carrier layers, and one outer upper and one outer lower face of the adhesive strip being formed by the layer or layers of pressure sensitive adhesive.

The adhesive strip, then, has an upper outer and a lower outer adhesive face, and neither the upper outer nor the lower outer face bears one or more further layers, more particularly no other layers of adhesive, which are part of the adhesive strip. The adhesive strip may be lined on one or both sides with a liner prior to use. Essential to the invention is that the outer faces of the adhesive strip, accessible to bonding, are formed by pressure sensitive adhesive, since only in that way is it possible to provide a strippable adhesive strip. Ultimately, as already described above, PSAs are adhesives which permit a durable bond to the substrate even under relatively weak applied pressure and which after service can be redetached substantially without residue from the substrate. Irrespective of this, the inventively employable adhesive strip may comprise, in at least one optional pull tab region, preferably on both sides, a further, typically antiadhesive, layer which is disposed on the respective exterior layer of PSA.

In accordance with the invention, the terms “adhesive strip” and “adhesive tape” are used synonymously. A strippable adhesive strip as disclosed herein is therefore also termed in accordance with the invention a strippable double-sided, i.e., double-sidedly adhesive, adhesive tape.

The use of the adhesive strip of the invention produces impervious, especially watertight, bonds of the components in the electrochemical cell or in the stack of electrochemical cells. The bonds of the invention can also be easily parted. As a result, the replacement of defective components and/or units in the electrochemical cell or in the stack of electrochemical cells can be made easier. In the present patent application, the terms “replacement” and “switching out” of defective components and/or units are used synonymously. The “replacement” or “switching out” of a defective component or unit of an electrochemical cell or of a stack of electrochemical cells may be understood on the one hand to mean that, after the removal of the defective component or unit from the cell or the stack, a new component or unit is installed in the cell or the stack. On the other hand it may mean that after the defective component or unit has been removed from the cell or stack, the defective component or unit is repaired and then reinstalled in the cell or stack. A “unit” in accordance with the invention is an assembly of components, such as an electrochemical cell in a stack of electrochemical cells, for example. The parting of the bonds of the invention in an electrochemical cell or a stack of electrochemical cells also makes it possible for defective components bonded in accordance with the invention, as an alternative to being replaced, can be repaired directly on the electrochemical cell or directly on the stack of electrochemical cells, via the surfaces exposed when the bonds in question are parted. In this case there is no need for removal of the defective components.

The adhesive strip used in accordance with the invention can typically be redetached without residue or destruction by extensive stretching substantially in the bond plane. “Detached without residue” in relation to the adhesive strip means in accordance with the invention that on detachment the strip leaves behind no residues of adhesive on the bonded surfaces of the components. Furthermore, “detachment without destruction” of the adhesive strip means in accordance with the invention that, on detachment, there is no damage, such as destruction, for example, to the bonded surfaces of the components. The residuelessly and nondestructively possible detachment of the adhesive strip reduces the risk of a lack of imperviosity on reassembly of the electrochemical cell or of the stack of electrochemical cells.

The electrochemical cell is preferably a fuel cell, more preferably a fuel cell with solid electrolyte membrane, and more particularly a fuel cell with polymer electrolyte membrane. Accordingly, the stack of electrochemical cells is preferably a stack of fuel cells, more preferably of fuel cells with solid electrolyte membrane, and more particularly of fuel cells with polymer electrolyte membrane. With further preference the electrochemical cell may be an electrolysis cell, preferably an electrolysis cell with solid electrolyte membrane, such as especially an electrolysis cell with polymer electrolyte membrane. Accordingly, the stack of electrochemical cells may alternatively be a stack of electrolysis cells, preferably of electrolysis cells with solid electrolyte membrane, and more particularly of electrolysis cells with polymer electrolyte membrane.

Further preferred embodiments of the electrochemical cell or of the stack of electrochemical cells are disclosed herein.

The present invention further relates to the use of a strippable, double-sided adhesive tape for bonding components in an electrochemical cell or in a stack of electrochemical cells to one another. The electrochemical cell and the stack of electrochemical cells here are preferably defined as above.

Further preferred embodiments of the use are disclosed herein.

The present invention relates, furthermore, to the use of a strippable, double-sided adhesive tape in the bonding of components in an electrochemical cell or in a stack of at least two electrochemical cells to one another for the purpose of achieving, in particular, residueless and nondestructive redetachability of the adhesive strip by extensive stretching of the adhesive strip substantially in the bond plane. The electrochemical cell and the stack of electrochemical cells here are preferably defined as above.

Further preferred embodiments of the use are disclosed herein.

In accordance with the invention, and as generally customary, a “pressure sensitive adhesive” is understood to be a substance which—in particular at room temperature—is durably tacky and also adhesive. Characteristic of a PSA is that it can be applied to a substrate by means of pressure, and remains adhering there, with the pressure to be employed and the duration of exposure to that pressure not being further defined. In certain cases, depending on the precise nature of the PSA, the temperature, the atmospheric humidity, and also the substrate, exposure to a minimal pressure for a short time, said pressure not going beyond gentle contact for a brief moment, is sufficient to achieve the adhesion effect; in other cases, a longer-term duration of exposure to a high pressure may also be necessary.

PSAs have particular, characteristic viscoelastic properties which result in the durable tack and adhesiveness. Characteristically, when PSAs are mechanically deformed, there are viscous flow processes and there is also development of elastic forces of resilience. The two processes, in terms of their respective proportion, have a certain ratio to one another, dependent not only on the precise composition, the structure, and the degree of crosslinking of the PSA, but also on the rate and duration of the deformation, and on the temperature too.

The viscous flow component is necessary for the attainment of adhesion. It is only the viscous components, brought about by macromolecules with relatively high mobility, that allow effective wetting and effective flow onto the substrate where bonding is to take place. A high viscous flow component results in high pressure-sensitive adhesiveness (also referred to as tack or surface adhesiveness) and hence often also in a high peel adhesion. A lack of flowable components means that highly crosslinked systems, crystalline polymers or those that have undergone glasslike solidification are in general not pressure-sensitively adhesive or have only little pressure-sensitive adhesiveness.

The component elastic forces of resilience are needed in order to achieve cohesion. They are brought about, for example, by very long-chain and highly coiled macromolecules, and also by physically or chemically crosslinked macromolecules, and they allow the forces acting on an adhesive bond to be transmitted. As a result of these elastic resilience forces, an adhesive bond is able to withstand a sustained load acting on it, in the form of a long-term shearing load, for example, to a sufficient degree and over a relatively long period of time.

For a more exact description and quantification of the extent of elastic and viscous components, and also of the ratio of the components to one another, the variables of storage modulus (G′) and loss modulus (G″) can be employed, and may be determined using dynamic mechanical analysis (DMA). G′ is a measure of the elastic component and G″ a measure of the viscous component of a substance. Both variables are dependent on the deformation frequency and the temperature.

The variables may be determined by means of a rheometer. In that case, the material for analysis is exposed to a sinusoidally oscillating shearing stress in a plate/plate arrangement, for example. In the case of instruments operating with shear stress control, measurements are made of the deformation as a function of time, and of the time offset of that deformation relative to the introduction of the shear stress. This time offset is referred to as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is as follows: G″=(τ/γ)·sin(δ) (τ=shear stress, γ=deformation, δ=phase angle=phase shift between shear stress vector and deformation vector).

A substance is held in general to be pressure-sensitively adhesive, and is defined as such in the sense of the invention, if at room temperature, here by definition at 23° C., in the deformation frequency range from 10⁰ to 10¹ rad/sec, G′ is located at least partly in the range from 10³ to 10⁷ Pa and if G″ is likewise at least partly within that range. “Partly” means that at least a section of the G′ curve lies within the window subtended by the deformation frequency range of from 10⁰ (inclusive) to 10¹ (inclusive) rad/sec (abscissa) and also with a range of G′ values from 10³ (inclusive) to 10⁷ (inclusive) Pa (ordinate). The same applies correspondingly for G″.

In order that adhesive strips can be redetached nondestructively and without residue by extensive stretching in the bond plane, they must possess certain technical adhesive properties. Thus there must be a distinct fall in the tack of the adhesive strips on stretching. The lower the bonding performance in the stretched state, the less significant the damage to the substrate on detachment or the less significant the risk that residues will remain on the bonding substrate. This property is particularly clearly apparent in the case of PSAs based on vinylaromatic block copolymers, for which the tack falls to below 10% in the vicinity of the yield point.

In order that adhesive strips can be detached again easily and without residue by extensive stretching, they must possess certain mechanical properties as well as the above-described technical adhesive properties. With particular advantage, the ratio of the tearing force and the stripping force is greater than two, preferably greater than three. The stripping force here is that force that has to be expended in order to redetach an adhesive strip from a bond by extensive stretching in the plane of the bond. This stripping force is made up of the force which is needed, as described above, for the detachment of the adhesive strip from the bonding substrates, and the force that has to be expended for deformation of the adhesive strip. The force needed for the deformation of the adhesive strip is dependent on the thickness of the adhesive strip. The force required for detachment, by contrast, is independent of the thickness of the adhesive strip within the range of adhesive strip thicknesses under consideration (20 to 2000 μm).

In accordance with the invention, at least two components of the electrochemical cell or of the stack of electrochemical cells are bonded to one another by means of an adhesive strip. Bonded to one another here typically means that in each case at least one subregion of a side face of a component is disposed opposite at least one subregion of a side face of at least one further component, and these regions are joined to one another by means of an adhesive strip. The side faces joined may lie in parallel planes, or else may have a curved implementation. The bond preferably has a constant thickness, but may also be implemented with a varying thickness.

Components of the electrochemical cell are considered typically to be all of the components or assemblies that can be managed as an individual part inherently and that contribute to the direct function of the electrochemical cell. Components typically not encompassed by the electrochemical cell are therefore, for example, a casing or packaging.

In one preferred embodiment of the present invention, the inventively employed adhesive strip consists of a single layer of pressure sensitive adhesive. A one-layer, double-sidedly adhesive tape of this kind, i.e., double-sided adhesive tape, is also referred to as “transfer tape”. The fact that an adhesive strip consists of a single layer of PSA does not in accordance with the invention mean that in at least one optional pull tab region, preferably on both sides, there may not be a further, typically antiadhesive, layer included that is disposed on the layer of PSA.

In an alternative embodiment, the inventively employed adhesive strip comprises a carrier layer and two layers of pressure sensitive adhesive, with the two PSA layers being disposed on the opposite surfaces of the carrier layer and forming one outer upper and one outer lower face of the adhesive strip. The system in question is therefore likewise a double-sided adhesive tape. In the present patent specification, “disposition” of the layers of PSA on the surfaces of the carrier layer may mean an arrangement in which the PSA layers are in direct contact with the surfaces of the carrier layer, i.e., are disposed directly on the surfaces. Alternatively it may also mean a disposition of a kind in which between at least one of the PSA layers, optionally both PSA layers, and the surfaces of the carrier layer there is at least one further layer. In the adhesive strip the two PSA layers are preferably in direct contact with the surfaces of the carrier layer. In this case the inventively employed adhesive strip consists of a carrier layer and two PSA layers, the two PSA layers being disposed on the opposite surfaces of the carrier layer and therefore forming one outer upper and one outer lower face of the adhesive strip. The fact that an adhesive strip consists of a carrier layer and two double-sidedly disposed PSA layers does not, in accordance with the invention, rule out the possibility of it comprising a further, typically antiadhesive, layer, preferably on both sides, in at least one optional pull tab region, said further layer being disposed on the respective exterior PSA layer.

Before being used to bond components of an electrochemical cell or of a stack of electrochemical cells to one another, the outer faces of the adhesive strip of the invention may optionally be furnished with double-sidedly antiadhesively coated materials such as a release paper or a release film, also called liner, specifically as a temporary carrier. Unless otherwise indicated, a liner (release paper, release film) in accordance with the present invention is not part of an adhesive strip, but merely an aid to its production, storage and/or for further processing by diecutting. Furthermore, in contrast to an adhesive tape carrier, a liner is not joined firmly to a layer of adhesive. Correspondingly, in the adhesive strip of the invention, the carrier, if present, is joined firmly to the adjacent layers of adhesive. In the present patent application, the terms “carrier” and “carrier layer” are used synonymously.

The adhesive strip of the invention may likewise comprise further layers, of a kind familiar to the skilled person in the area of adhesive tapes, such as, for example, further adhesive layers or carrier layers, primers or release layers, or layers having specific physical functions (e.g., optically active layers, permeation-inhibiting or gap-promoting layers, thermally or electrically conductive layers). Before being used to bond an electrochemical cell or a stack of electrochemical cells, the adhesive strip may be provided, for example, in the form of a sheet, a roll or a diecut. It may completely cover the area bounded by its external periphery, or else may leave parts thereof free, as in the case, for example, of a framelike diecut or a perforated section. With preference all layers of the adhesive strip have substantially the shape of a cuboid. With further preference all the layers are joined to one another over their full area. Optionally it is possible for there to be one or more, typically nonadhesive, pull tab regions, starting from which the detachment operation can be performed.

The general expression “adhesive tape” in the sense of this invention encompasses all sheetlike structures such as two-dimensionally extended films or film sections, tapes with extended length and limited width, tape sections, diecuts, labels, and the like.

The adhesive strip used in accordance with the invention for bonding components of an electrochemical cell or stack of electrochemical cells to one another is preferably embodied such that it has at least one typically nonadhesive pull tab region, starting from which the detachment operation can be implemented by extensive stretching, said region projecting beyond those surfaces of the components that are to be bonded. A nonadhesive pull tab region has a number of advantages over an adhesive pull tab region. First, it typically remains uncontaminated for longer in a wide variety of different environments. Secondly, it is easier to use during removal, and in particular can be separated from the fingers again more effectively after removal.

Typically, the pull tab region of the adhesive strip is not adhesive, and the pull tab region preferably
(i) is an extension of the carrier layer optionally present, or
(ii) is an extension of the layer sequence of the adhesive strip, one antiadhesive layer in each case being disposed in the pull tab region on one outer upper and one outer lower face of the adhesive strip, independently of one another. The antiadhesive layer is preferably double-sidedly antiadhesively coated material such as a release paper or a release film. It may, for example, be a double-sidedly siliconized release paper or a double-sidedly siliconized release film. The layer sequence may also be a single layer—when, that is, the adhesive strip consists of a single layer of PSA.

Alternatively the pull tab region is adhesive. In that case it is typically an extension of the layer sequence of the adhesive strip, there being no antiadhesive layer disposed on the two surfaces of the adhesive strip in the pull tab region. In a further alternative embodiment, the pull tab region is adhesive in one subregion and nonadhesive in a further subregion. This also includes a variant wherein one surface of the pull tab region is adhesive and the other surface of the pull tab region is nonadhesive.

In one embodiment of the invention, the adhesive strip used in the electrochemical cell or in the stack of electrochemical cells is embodied such that the components bonded to one another by means of the adhesive strip are bonded over the full area.

In one preferred embodiment of the invention, the adhesive strip used in the electrochemical cell or in the stack of electrochemical cells is embodied such that the components bonded to one another by means of the adhesive strip are bonded over part of the area, with the adhesive strip in particular (i) taking the form of an adhesive tape section (diecut), which brings about a bond at the periphery of the components, and/or (ii) having at least one perforation. In the case of the part-area bonding, for example, media-carrying regions within the bonding faces of the adhesive strip are kept free or the bonding takes place only at the periphery of the components to be bonded, such as, for example, the bonding of a bipolar plate or bipolar half-plate to the marginal reinforcement of a membrane-electrode assembly of a fuel cell. The diecut is preferably a frame-shaped diecut, since in that case the redetachment of the adhesive strip by extensive stretching substantially in the bond plane is made easier.

As layers of pressure sensitive adhesive which are redetachable by extensive stretching it is possible to use all PSA layers known to the skilled person that exhibit this property.

Inventively employable adhesive strips are known from, for example, U.S. Pat. No. 4,024,312 A, DE 33 31 016 C2, WO 92/11332 A1, WO 92/11333 A1, DE 42 22 849 C1, WO 95/06691 A1, DE 195 31 696 A1, DE 196 26 870 A 1, DE 196 49 727 A1, DE 196 49 728 A 1, DE 196 49 729 A1, DE 197 08 364 20 A1, DE 197 20 145 A1, DE 198 20 858 A1, WO 99/37729 A1, WO 2002 004571 A1, DE 100 03 318 A1, DE 42 33 872 C1, DE 195 11 288 C1, U.S. Pat. No. 5,507,464 B1, U.S. Pat. No. 5,672,402 B1, and WO 94/21157 A1. Specific embodiments of an inventively employable adhesive strip are also described in DE 44 28 587 C1, DE 44 31 914 C1, WO 97/07172 A1, DE 196 27 400 A1, WO 98/03601 A1 and DE 196 49 636 A1, 30 DE 197 20 526 A1, DE 197 23 177 A1, DE 197 23 198 A1, DE 197 26 375 A 1, DE 197 56 084 C1, DE 197 56 816 A1, DE 198 42 864 A1, DE 198 42 865 A1, WO 99/31193 A1, WO 99/37729 A1, WO 99/63018 A1, WO 00/12644 A1, DE 199 38 693 A1, WO 2014/095382 A1, WO 00/13888 A1, and DE 10 2007 034474 A1.

The adhesive strip of the invention may for example comprise at least one PSA layer which is based on acrylate copolymer, silicone (co)polymer, nitrile rubber, i.e., acrylonitrile-butadiene rubber, or chemically or physically crosslinked synthetic rubber.

PSA layers based on acrylate copolymer, however, especially on nonpolar substrates, attain lower bond strengths and suffer less of a loss of peel adhesion during the extensive stretching than is the case, for example, with PSA layers based on vinylaromatic block copolymer. From the group of the acrylate copolymers, preference is given to using UV-crosslinked acrylate copolymers or acrylate block copolymers. DE 101 29 608 A1, for instance, discloses strippable adhesive strips which comprise at least one PSA based on acrylate block copolymers. Acrylate block copolymer-based PSA layers typically do not have the very high peel adhesions achievable in particular with resin-modified polystyrene-polydiene block copolymers, but do have an increased drop in peel adhesion during the extensive stretching, relative to other acrylate polymers. Acrylate block copolymer-based PSA layers, moreover, are preferred on account of their high long-term temperature stability.

If the adhesive strip of the invention comprises at least one PSA layer based on acrylate block copolymer, then the PSA layer is typically a PSA layer based on at least one block copolymer which is constructed at least partially of (meth)acrylic acid derivatives, the block copolymer comprising at least the unit P(A)-P(B)-P(A) composed of at least one polymer block P(B) and at least two polymer blocks P(A), and
P(A) independently of one another representing homopolymer or copolymer blocks of monomers A, the polymer blocks P(A) each having a softening temperature in the range from +20° C. to +175° C., i.e., representing a hard block,
P(B) representing a homopolymer or copolymer block of monomers B, the polymer block P(B) having a softening temperature in the range from −100° C. to +10° C., i.e., representing an elastomer block, and
the polymer blocks P(A) and P(B) being not homogeneously miscible with one another.

PSA layers based on acrylate block copolymers of these kinds exhibit, in particular, a high stability toward exposure to light, especially UV radiation, to thermooxidative degradation, and to ozonolysis. Furthermore, they exhibit distinct losses of tack on stretching and so guarantee a reliable detachment operation of the adhesive strip by extensive stretching. Additional features of such PSA layers include the following criteria:
possibility of using a large number of monomers for the synthesis of the PSA, so that a broad palette of pressure-sensitive adhesion properties can be established through the chemical composition;
multiple reusability of the strippable adhesive strips;
low stress values in the range of moderate elongations of around 200% to 400%, and hence easy redetachment by extensive stretching in the bond plane;
enablement of the production of thick, highly cohesive PSA layers, of the kind required for—among other things—producing single-layer strippable adhesive strips;
possibility of choice in the use of the comonomers, thus allowing the thermal stability to be controlled, and, in particular, a persistently good cohesion and hence holding power at high temperatures (>+60° C.).

Strippable adhesive strips based on such acrylate block copolymer-containing PSAs exhibit, surprisingly, a loss of tack under stretching that is essential for residueless and nondestructive detachment.

The construction of the block copolymer/block copolymers may preferably be described by one or more of the following general formulae:

P(A)-P(B)-P(A),P(B)—P(A)-P(B)-P(A)-P(B),[P(A)-P(B)]ₙX,[P(B)-P(A)-P(B)]ₙX and/or [P(A)-P(B)]ₙX[P(B)]ₘ,
where n=2 to 12, m=1 to 12, and X represents a difunctional or polyfunctional branching region,
where the polymer blocks P(A) independently of one another represent homopolymer or copolymer blocks of the monomers A, the polymer blocks P(A) each having a softening temperature in the range from +20° C. to +175° C.,
and where the polymer blocks P(B) independently of one another represent homopolymer or copolymer blocks of the monomers B, the polymer blocks P(B) each having a softening temperature in the range from −100° C. to +10° C.

Preferably, also, the ratio of the chain lengths of the polymer blocks P(A) to those of the polymer blocks P(B) is selected such that the polymer blocks P(A) are present in the form of a disperse phase (“domains”) in a continuous matrix of the polymer blocks P(B), especially as spherical or distortedly spherical domains.

Monomers used advantageously for the elastomer block P(B) are acrylic monomers. For this purpose it is possible in principle to use all acrylic compounds which are familiar to the skilled person and are suitable for the synthesis of polymers. Monomers selected are preferably those which, also in combination with one or more further monomers, entail softening temperatures of the polymer block P(B) of less than +10° C. The vinyl monomers, preferably, can be selected correspondingly.

The polymer blocks P(B) are advantageously prepared using 75 to 100 wt % of acrylic and/or methacrylic acid derivatives of the general structure CH₂═CH(R¹)(COOR²), where R¹═H or CH₃ and R²═H or linear, branched or cyclic, saturated or unsaturated alkyl radicals having 1 to 30, especially having 4 to 18, carbon atoms, and 0 to 25 wt % of vinyl compounds which favorably contain functional groups. Acrylic monomers used very preferably as components for polymer blocks P(B) comprise acrylic and methacrylic acid alkyl esters having alkyl groups consisting of 4 to 9 C atoms. Specific examples of corresponding compounds, without wishing to be restricted by this enumeration, are n-butyl acrylate, n-pentyl acrylate, n-hexyl acrylate, n-heptyl acrylate, n-octyl acrylate, n-nonyl acrylate, their branched isomers, such as 2-ethylhexyl acrylate and isooctyl acrylate, for example, and also cyclic monomers, such as cyclohexyl or norbornyl acrylate and isonorbornyl acrylate, for example. As monomers for polymer blocks P(B) it is further possible, optionally, to use vinyl monomers from the following groups: vinyl esters, vinyl ethers, vinyl halides, vinylidene halides, and vinyl compounds containing aromatic rings and heterocycles in α-position. Here as well, mention may be made on an exemplary basis of selected monomers usable in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile.

Starting monomers for the polymer blocks P(A) are preferably selected such that the resulting polymer blocks P(A) are not miscible with the polymer blocks P(B) and, accordingly, microphase separation occurs. Advantageous examples of compounds used as monomers A are vinylaromatics, methyl methacrylate, cyclohexyl methacrylate, and isobornyl methacrylate. Particularly preferred examples are methyl methacrylate and styrene; this enumeration makes no claim to completeness.

Additionally, however, the polymer blocks P(A) may also be constructed as a copolymer which may consist to an extent of at least 75 wt % of the above monomers A, leading to a high softening temperature, or of a mixture of these monomers, but contains up to 25 wt % of monomers B which lead to a lowering of the softening temperature of the polymer block P(A).

In another favorable embodiment of the inventive strippable systems, polymer blocks P(A) and/or P(B) are functionalized in such a way as to allow thermally initiated crosslinking to be carried out. Crosslinkers which may favorably be selected include the following: epoxides, aziridines, isocyanates, polycarbodiimides, and metal chelates, to name but a few.

In a further preferred embodiment, the PSA layer based on acrylate block copolymers is admixed with tackifier resins, especially those compatible with the polymer blocks P(B), preferably in a weight fraction of up to 40 wt %, very preferably up to 30 wt %, based on the PSA layer, and/or the PSA layer is admixed with plasticizers, fillers, nucleators, expandants, compounding agents and/or aging inhibitors.

A “tackifier resin” is understood, in accordance with the general understanding of the skilled person, to be a low-molecular, oligomeric or polymeric resin which increases the adhesion (the tack, the inherent adhesiveness) of the PSA in comparison to an otherwise identical PSA containing no tackifier resin.

Alternatively the adhesive strip of the invention may comprise at least one PSA layer based on solid acrylonitrile-butadiene rubber and further comprising tackifier resin, the fraction of tackifier resin being in total 30 to 130 phr. PSA layers of these kinds are disclosed in DE 10 2015 215 247 A1. They are inexpensive and resistant to a wide variety of different chemicals, and in particular do not lose peel adhesion even after prolonged storage in various media. Adhesive strips of the invention which comprise at least one such PSA layer can be redetached without residue or destruction, moreover, by extensive stretching not only in the bond plane but also at an angle of more than 45°, such as of 90°, for example, relative to the bond plane. In particular, the susceptibility to tears, i.e., the frequency of tearing of the adhesive strip during the extensive stretching, both in the bond plane and also at an angle of more than 45°, such as of 90°, for example, relative to the bond plane, is very low. Adhesive strips of this kind customarily have a high shock resistance as well.

If the fraction of tackifier resin in the PSA layer based on solid acrylonitrile-butadiene rubber is in total 30 to 130 phr, the PSA layer is in particular characterized at the same time by good adhesion and cohesion values. The figures in phr (“parts per hundred rubber”) given in the present patent application denote in each case parts by weight of the relevant component relative to 100 parts by weight of all solid rubber components of the PSA—that is, for example, without taking account of tackifier resin or liquid rubber.

Liquid rubbers are notable relative to solid rubbers in that they have a softening point, i.e., a softening temperature (ring & ball, according to ASTM E28), of less than 40° C. Solid rubbers are therefore characterized in that they do not have a softening point of less than 40° C.

The acrylonitrile content in the solid acrylonitrile-butadiene rubber of the PSA layer is preferably between 10 and 45 wt %, more preferably between 10 and 30 wt %, more preferably still between 10 and 25 wt %, and more particularly between 15 and 20 wt %. In these ranges it is possible to achieve particularly low tear susceptibilities and particularly high shock resistances. The fraction of solid acrylonitrile-butadiene rubber in the PSA based on solid acrylonitrile-butadiene rubber of the PSA layer is in total preferably at least 50 wt %, based on the total weight of the PSA layer.

In the PSA layer based on solid acrylonitrile-butadiene rubber of the adhesive strip of the invention, there may preferably be, as a further base polymer, at least one liquid acrylonitrile-butadiene rubber, with the acrylonitrile content in the at least one liquid acrylonitrile-butadiene rubber being preferably between 10 and 45 wt %, more preferably between 10 and 30 wt %, more preferably still between 10 and 25 wt %, and more particularly between 15 and 20 wt %. The fraction of liquid acrylonitrile-butadiene rubber in the PSA layer based on solid acrylonitrile-butadiene rubber is in total preferably up to 20 wt %, more preferably between 1 and 15 wt %, and more particularly between 2 and 10 wt %, based in each case on the total weight of the PSA layer.

In the PSA layer based on solid acrylonitrile-butadiene rubber, the acrylonitrile-butadiene rubber may be admixed, for the purpose of improving the processing properties, with thermoplastic elastomers such as, for example, synthetic rubbers, with a fraction of up to 5 wt %, based on the total weight of the PSA layer. Representatives that may be mentioned at this point include in particular the especially compatible styrene-isoprene-styrene (SIS) and styrene-butadiene-styrene (SBS) types.

In the PSA layer based on solid acrylonitrile-butadiene rubber, the fraction of tackifier resin is preferably in total 40 to 120 phr, more preferably in total 50 to 110 phr, and more particularly in total 60 to 100 phr. By this means it is possible typically at the same time to achieve particularly good adhesion and cohesion values. Tackifier resins which can be used in the PSA layer are, in particular, hydrogenated and unhydrogenated hydrocarbon resins and polyterpene resins.

Alternatively the adhesive strip of the invention may comprise at least one PSA layer based on polyisobutylene homopolymer and/or polyisobutylene copolymer. One such adhesive strip is described, for example, by WO 2010/141248 A1. The copolymers may for example be random copolymers, block copolymers, or a mixture thereof. The copolymers are typically formed of isobutylene to an extent of at least 75 wt %, preferably at least 80 wt %, more preferably at least 85 wt %, and more particularly to an extent of at least 90 wt %. PSA layers based on polyisobutylene homopolymer and/or polyisobutylene copolymer do have a low peel adhesion, but are preferred on account of their low water vapor permeability. The latter is true in particular in their embodiment as polyisobutylene block copolymer-based PSAs. In accordance with the invention, a polyisobutylene block copolymer is a block copolymer including at least one polymer block formed predominantly by polymerization of isobutylene.

The polyisobutylene polymer (homopolymer and/or copolymer) of the PSA layer may be a cured polymer. Furthermore, the PSA layer may comprise tackifier resin.

The adhesive strip of the invention preferably comprises at least one PSA layer based on vinylaromatic block copolymer. Such PSA layers may have particularly high peel adhesions and at the same time a high drop in peel adhesion during the extensive stretching.

The vinylaromatic block copolymers preferably comprise polymer blocks (i) predominantly formed of vinylaromatics (A blocks), preferably styrene, and at the same time (ii) blocks formed predominantly by polymerization of 1,3-dienes (B blocks), such as butadiene, isoprene or a mixture of the two monomers, for example, or of butylenes (B blocks), such as isobutylene, for example. These B blocks typically have a low polarity. Both homopolymer and copolymer blocks can be utilized as B blocks.

The vinylaromatic block copolymers resulting from the A and B blocks may comprise identical or different B blocks, which may have been partly, selectively or fully hydrogenated. The B blocks are preferably fully hydrogenated, i.e., saturated, since the resultant block copolymers have better aging resistance. The block copolymers may have linear A-B-A structures. Likewise employable are block copolymers of radial architecture, and also star-shaped and linear multiblock copolymers. Further components present may include A-B two-block copolymers. All of the aforesaid polymers may be utilized alone or in a mixture with one another. Preference is given to A-B-A triblock copolymers and, as a further component, A-B diblock copolymers.

The vinylaromatic block copolymer employed preferably comprises at least one synthetic rubber in the form of a block copolymer having an A-B, A-B-A, (A-B)ₙ, (A-B)ₙX or (A-B-A)ₙX construction, in which the blocks A independently of one another are a polymer formed by polymerization of at least one vinylaromatic, the blocks B independently of one another are a polymer formed by polymerization of conjugated dienes having 4 to 18 C atoms, or are a partly, selectively or fully hydrogenated derivative of such a polymer, X is the residue of a coupling reagent or initiator, and n is an integer 2.

In one preferred embodiment, accordingly, the vinylaromatic blocks A of the vinylaromatic block copolymers are endblocks.

In place of the preferred polystyrene blocks as vinylaromatics in the vinylaromatic block copolymers it is also possible to use polymer blocks based on other aromatic-containing homopolymers and copolymers (preferably C₈ to C₁₂ aromatics) having glass transition temperatures of more than 75° C., such as, for example, α-methylstyrene-containing aromatic blocks. Furthermore, identical or different A blocks may also be present.

The monomer for the block B of the vinylaromatic block copolymer is preferably selected from the group consisting of butadiene, (iso)butylene, isoprene, ethylbutadiene, phenylbutadiene, piperylene, pentadiene, hexadiene, ethylhexadiene, and dimethylbutadiene, and also any desired mixture of these monomers, and especially butadiene, isoprene or a mixture of the two monomers.

Use may also be made of vinylaromatic block copolymers which as well as the above-described blocks A and B include at least one further block, such as A-B-C block copolymers, for example.

Also conceivable, though not preferred in accordance with the invention, is the use of PSA layers based on block copolymers in which the aforementioned B blocks are combined with A blocks whose chemical nature is different from that of vinylaromatics, and which have a glass transition temperature above the ambient temperature (20° C.), such as polymethyl methacrylate, for example.

As vinylaromatic block copolymer it is also possible to use at least one synthetic rubber in the form of a block copolymer having an A-B-A, (A-B)ₙ, (A-B)ₙX or (A-B-A)ₙX construction, in which the blocks A independently of one another are a polymer formed by polymerization of at least one vinylaromatic, where at least some of the blocks A are sulfonated, the blocks B independently of one another are a polymer formed by polymerization of dienes or of alkenes, X is the residue of a coupling reagent or initiator, and n is an integer in the range from 2 to 10. The PSA layer, as well as a vinylaromatic block copolymer of this kind, may also comprise at least one metal complex with a substitutable complexing agent. A PSA layer of this kind exhibits excellent temperature stability. More particularly it is tacky over a wide temperature range and exhibits high bond strength even at high temperatures.

Known commercial examples of vinylaromatic block copolymers include those under the Kraton name from Kraton (Kraton D 1101 and 1102 as styrene-butadiene-styrene block copolymers, Kraton D 1107 or 1163 as styrene-isoprene-styrene block copolymers, or Kraton G 1652 as a hydrogenated styrene-butadiene-styrene block copolymer), under the Europrene name from Polimeri Europa (styrene block copolymers with isoprene, butadiene or hydrogenation products thereof) or under the Septon name from Kuraray (hydrogenated styrene-isoprene-styrene block copolymers). A-B-C vinylaromatic block copolymers are available for example under the SBM name from Arkema.

Where the adhesive strip of the invention comprises one or more PSA layers constructed on the basis of vinylaromatic block copolymers, the block copolymers preferably have a polyvinylaromatic fraction of 10 wt % to 35 wt %.

Furthermore, the fraction of the vinylaromatic block copolymers in total, based on the overall PSA layer, is preferably at least 20 wt %, more preferably at least 30 wt %, more preferably still at least 35 wt %. A consequence of an inadequate fraction of vinylaromatic block copolymers is that the cohesion of the PSA is relatively low. The maximum fraction of the vinylaromatic block copolymers in total, based on the overall PSA layer, is preferably not more than 80 wt %, more preferably not more than 65 wt %, very preferably not more than 60 wt %. The consequence of too high a fraction of vinylaromatic block copolymers, in turn, is that the PSA is barely still tacky.

In another preferred embodiment, the one or more PSA layers based on vinylaromatic block copolymer have at least one tackifier resin, in order to increase the adhesion in a desired way. The tackifier resin ought to be compatible with the elastomer block of the block copolymers. In the one or more PSA layers, the tackifier resin is present preferably in a fraction of 20 to 60 wt %, more preferably 30 to 50 wt %, based in each case on the total weight of the PSA layer.

Preferred tackifier resins are those having a DACP (diacetone alcohol cloud point) of more than 30° C., especially with a DACP of more than 37° C., and with an MMAP (mixed methylcyclohexane aniline point) of greater than 50° C., especially an MMAP of greater than 60° C. The DACP and the MMAP each indicate the solubility in a particular solvent. The selection of these ranges results in a particularly high permeation barrier, especially toward water vapor.

Further preferred are tackifier resins having a softening temperature (ring & ball, according to ASTM E28) of more than 95° C., especially more than 100° C. This selection produces a particularly high permeation barrier, especially toward oxygen.

Tackifier resins which can be used in the PSA layer include, for example, unhydrogenated or partially or fully hydrogenated resins based on rosin and on rosin derivatives, hydrogenated polymers of dicyclopentadiene, unhydrogenated or partially, selectively or fully hydrogenated hydrocarbon resins based on C₅, C₅/C₉ or C₉ monomer streams, polyterpene resins based on α-pinene and/or β-pinene and/or δ-limonene, and hydrogenated polymers of preferably pure C₈ and C₉ aromatics. Aforesaid tackifier resins may be used either alone or in a mixture. The resins which can be used include those which at room temperature are solid and those which are liquid. To ensure high aging and UV stability, preferred hydrogenated resins are those having a degree of hydrogenation of at least 90%, preferably at least 95%.

Preference is given to using a strippable PSA layer which consists of an elastomer part (a1), a tackifier resin part (a2), optionally a plasticizing resin part (a3), and optionally further additives (a4), where
at least 90 wt % of the elastomer part (a1) consists of polyvinylaromatic-polydiene block copolymers, especially polyvinylaromatic-polybutadiene block copolymers, the amount of polyvinylaromatics in the polyvinylaromatic-polydiene block copolymers is at least 12 wt % and at most 35 wt %, preferably at least 20 wt % and at most 32 wt %, and the fraction of the elastomer part (a1), based on the overall PSA, is at least 40 wt % and at most 55 wt %, preferably at least 45 wt %,
at least 90 wt %, preferably at least 95 wt %, of the tackifier resin part (a2) consists of hydrocarbon resins which are substantially compatible with the polydiene blocks and substantially incompatible with the polyvinylaromatic blocks, and where the fraction of the tackifier resin part (a2), based on the overall adhesive A, is at least 40 wt % and at most 60 wt %,
the plasticizing resin part (a3), based on the overall adhesive, is 0 wt % to at most 5 wt %.

If the sum total of the weight fractions of elastomer part (a1), of tackifier resin part (a2), and of plasticizing resin part (a3) does not make 100 wt %, the remainder to 100 wt % is formed by the additives (a4).

The one or more PSA layers may comprise further additives, such as more particularly:
primary antioxidants, as for example sterically hindered phenols, preferably with a fraction of 0.2 to 1 wt %, based on the total weight of the PSA layer,
secondary antioxidants, as for example phosphites, thioesters or thioethers, preferably with a fraction of 0.2 to 1 wt %, based on the total weight of the PSA layer,
process stabilizers such as, for example, C radical scavengers, preferably with a fraction of 0.2 to 1 wt %, based on the total weight of the PSA layer,
light stabilizers such as, for example, UV absorbers or sterically hindered amines, preferably with a fraction of 0.2 to 1 wt %, based on the total weight of the PSA layer,
processing assistants, preferably with a fraction of 0.2 to 1 wt %, based on the total weight of the PSA layer,
endblock reinforcer resins, preferably with a fraction of 0.2 to 10 wt %, based on the total weight of the PSA layer,
plasticizing agents, as for example plasticizer oils, or low molecular mass liquid polymers, such as low molecular mass polybutenes, for example, and/or
optionally further polymers of preferably elastomeric kind; elastomers utilizable accordingly include those based on pure hydrocarbons, as for example unsaturated polydienes such as natural or synthetically produced polyisoprene or polybutadiene, elastomers with substantial chemical saturation such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, allyl or vinyl ether-containing polyolefins, preferably with a fraction of 0.2 to 10 wt %, based on the total weight of the PSA layer.

By “endblock reinforcer resins” are meant, in accordance with the invention, resins which are compatible with the endblocks of any block copolymers present in the PSA layers, such as vinylaromatic endblocks in particular, but which possess a higher softening point than the pure endblocks. Vinylaromatic (end)blocks in accordance with the present invention are those (end)blocks formed predominantly of vinylaromatics. As a result, the softening temperature of the PSA is raised. Known endblock reinforcer resins are primarily aromatic C₈ and C₉ resins, described as for example in EP 1 013 733 B1, WO 00/75247 A1, EP 2 064 299 B1 or WO 08/042645 A1. Also employed are polyphenylene oxides and/or polyphenylene ethers, described for example in WO 00/24840 A1 or WO 03/011954 A1. Endblock reinforcer resins generally possess a softening temperature (ring & ball, according to ASTM E28) of more than 115° C.

The nature and amount of the blending components may be selected in accordance with requirements. If migratable additives are employed in the PSA layers, then additives of the same kind are preferably likewise used in the carrier layer, if present.

In one embodiment of the inventively employed adhesive strip, the PSA layer also comprises further additives—mention may be made by way of example, but without limitation, of crystalline or amorphous oxides, hydroxides, carbonates, nitrides, halides, carbides or mixed oxide/hydroxide/halide compounds of aluminum, of silicon, of zirconium, of titanium, of tin, of zinc, of iron or of the alkali(ne earth) metals. These are, substantially, aluminas—for example, aluminum oxides, boehmite, bayerite, gibbsite, diaspore, and the like.

Especially preferred are phyllosilicates such as, for example, bentonite, montmorillonite, hydrotalcite, hectorite, kaolinite, boehmite, mica, vermiculite, or mixtures thereof. Use may also be made, however, of carbon blocks or other modifications of carbon, such as carbon nanotubes.

The PSA layers may also have been colored with dyes or pigments. The adhesives may be white, black or colored.

The addition of modified silicas, advantageously of precipitated silicas surface-modified with dimethyldichlorosilane, is preferentially utilized in order to establish the thermal shear strength of the PSA layer.

Preferred for the PSA layer of the invention, moreover—and selected independently of other additives—are solid polymer spheres, hollow glass spheres, solid glass spheres, hollow ceramic spheres, solid ceramic spheres and/or solid carbon spheres (“carbon microballoons”). Less suitable are expandable or expanded hollow polymer spheres, because in general they lack sufficient thermal stability.

Use in an electrochemical cell or in a stack of electrochemical cells necessitates, for certain bonds, an electrically conductive PSA layer. It is therefore preferred for conductive fillers to have been added to the strippable PSA suitable for the invention. These may be all of the fillers familiar to the skilled person; preferred are:
carbon black-graphite mixtures
titanium nitride
carbon nanofibers
particles of or coated with silver
   and also combinations thereof with one another or of other conductive substances.

Preferred conductive substances are those which do not give rise to any adverse effect on the catalyst—platinum, for example—optionally utilized in the electrochemical cell. Less preferred examples therefore include nickel, copper, and iron.

In another version, the inventively employed PSAs are crosslinked preferably before or even, optionally, after flow onto the surface, of a carrier or liner, for example, in which case the crosslinking levels targeted are those which continue to permit high flexibility and effective adhesion of the material. After crosslinking, the PSA preferably has an elongation at break of at least 20%, and especially of at least 100%. An elongation at break of this kind is particularly preferred in terms of maximum flexibility in design of the PSA.

In one preferred procedure, the PSA is crosslinked with UV radiation or electron beams. A comprehensive description of the state of the art, and the most important process parameters in relation to crosslinking, are known to the skilled person from, for example, “Chemistry and Technology of UV and EB formulation for Coatings, Inks and Paints” (Vol. 1, 1991, SITA, London). Moreover, other processes can be used as well that permit high-energy irradiation.

To reduce the required radiation dose, the viscoelastic material may be admixed with crosslinkers and/or crosslinking promoters, especially crosslinkers and/or promoters that can be excited by UV, by electron beams and/or thermally. Suitable crosslinkers for radiation crosslinking are monomers or polymers containing, for example, the following functional groups: acrylate or methacrylate, epoxy, hydroxyl, carboxyl, vinyl, vinyl ether, oxetane, thiol, acetoacetate, isocyanates, allyl, or unsaturated compounds in general. The monomers or polymers used may have a functionality of two or more, depending on the crosslinking-level requirements.

In a further preferred variant, the PSAs are crosslinked with thermally activatable crosslinkers. Admixed for that purpose are, preferably, peroxides, acids or acid anhydrides, metal chelates, di- or polyfunctional epoxides, di- or polyfunctional hydroxides, and di- or polyfunctional isocyanates, as described for acid anhydrides, for instance, in EP 1311559 B1.

Besides the monomeric crosslinkers having the described functional groups, preference is given to using vinylaromatic block copolymers functionalized with these crosslinking groups. Use is made advantageously of functionalized vinylaromatic block copolymers such as the Kraton FG series (e.g., Kraton FG 1901 or Kraton FG 1924), Asahi Tuftec M 1913 or Tuftec M 1943, or Septon HG252 (SEEPS-OH). Other preferred block copolymers are available, for example, under the name Epofriend A 1005, A 1010 or A 1020 from Daicel. By addition of suitable crosslinking agents (e.g., polyfunctional isocyanates, amines, epoxys, alcohols, thiols, phenols, guanidines, mercaptans, carboxylic acids and/or acid anhydrides), these block copolymers may be crosslinked thermally or by radiation. A combination of acid- or acid anhydride-modified vinylaromatic block copolymer (e.g., Kraton FG series) and an epoxidized vinylaromatic block copolymer (e.g., Daicel Epofriend series) can also advantageously be utilized. As a result, crosslinking can be brought about without monomeric crosslinkers, so that there are no monomeric constituents left over even if crosslinking is incomplete. A mixture of the functionalized monomers or polymers is likewise employable.

For use in an electrochemical cell or in a stack of electrochemical cells, crosslinked strippable PSA layers are preferred over their noncrosslinked counterparts, because the crosslinked PSA layers are better at withstanding the operating temperatures above the ambient temperature. Especially preferred are PSA layers based on vinylaromatic block copolymers with crosslinked vinylaromatic endblocks.

For use in platinum-catalyzed electrochemical cells, furthermore, it is preferred if the PSA is substantially free of platinum poisons. Substantially free here denotes a mass fraction of less than 100 ppm per substance. Known platinum poisons include arsenic, phosphorus, boron, bismuth, silicon, sulfur, lead, zinc, tin, antimony, silver, copper, nickel, and iron in their elemental or ionic form.

The inventively employed adhesive strip may comprise one or more carrier layers, i.e., carriers. The extensibility of the at least one carrier must be sufficient to ensure detachment of the adhesive strip by extensive stretching. Accordingly, the carrier layer, if present, preferably has an elongation at break of at least 100%, more preferably of at least 300%, more preferably still of at least 400%, and more particularly of at least 500%, such as of at least 600%, for example, in the longitudinal direction and/or the transverse direction, more particularly in the longitudinal direction and the transverse direction.

Highly extensive films may serve as carriers, for example. Examples of extensible carriers advantageously employable are transparent versions, from WO 2011/124782 A1, DE 10 2012 223670 A1, WO 2009/114683 A1, WO 2010/077541 A1, WO 2010/078396 A1.

The carrier film is produced using film-forming or extrudable polymers, which additionally may have undergone monoaxial or biaxial orientation.

One preferred version uses polyolefins. Preferred polyolefins are prepared from ethylene, propylene, butylene and/or hexylene, where in each case the pure monomers can be polymerized, or mixtures of the stated monomers are copolymerized. The polymerization process and the selection of the monomers allow control over the physical and mechanical properties of the polymer film, such as the softening temperature and/or the tear strength, for example. Particularly preferred are low-density polyethylenes, thus having a density of 0.94 g/cm³ or less, because they exhibit comparatively low water vapor permeability and hydrogen permeability.

Polyurethanes can be used, further, advantageously as starting materials for extensible carrier layers. Polyurethanes are chemically and/or physically crosslinked polycondensates constructed typically from polyols and isocyanates. According to the nature and ratio of use of the individual components, extensible materials are obtainable which can be employed advantageously for the purposes of this invention. Raw materials available to the formulator for this purpose are, for example, stated in 0894841 and 1308492. The skilled person knows of further raw materials from which carrier layers of the invention can be constructed. It is advantageous, furthermore, to use rubber-based materials in carrier layers in order to bring about extensibility. As rubber or synthetic rubber or blends thereof, as starting material for extensible carrier layers, the natural rubber may in principle be selected from all available grades, such as, for example, crepe, RSS, ADS, TSR or CV types, according to required level of purity and of viscosity, and the synthetic rubber or synthetic rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes and/or blends thereof.

Employable with particular advantage as materials for extensible carrier layers are block copolymers. Here, individual polymer blocks are linked covalently to one another. The block linkage may be in a linear form, or else in a star-shaped or graft copolymer variant. One example of an advantageously employable block copolymer is a linear triblock copolymer whose two terminal blocks have a softening temperature (ring & ball, according to ASTM E28) of at least 40° C., preferably at least 70° C., and whose middle block has a softening temperature (ring & ball, according to ASTM E28) of at most 0° C., preferably at most −30° C. Higher block copolymers, such as tetrablock copolymers, are likewise employable. It is important that the block copolymer comprises at least two polymer blocks of the same or different kind that have a softening temperature (ring & ball, according to ASTM E28) in each case of at least 40° C., preferably at least 70° C., and which are separated from one another via at least one polymer block having a softening temperature (ring & ball, according to ASTM E28) of at most 0° C., preferably at most −30° C., in the polymer chain. Examples of polymer blocks are polyethers such as, for example, polyethylene glycol, polypropylene glycol or polytetrahydrofuran, polydienes, such as, for example, polybutadiene or polyisoprene, hydrogenated polydienes, such as, for example, polyethylene-butylene or polyethylene-propylene, polyesters, such as, for example, polyethylene terephthalate, polybutanediol adipate or polyhexanediol adipate, polycarbonate, polycaprolactone, polymer blocks of vinylaromatic monomers, such as, for example, polystyrene or poly-[α]-methylstyrene, polyalkyl vinyl ethers, polyvinyl acetate, polymer blocks of [α],[β]-unsaturated esters such as, in particular, acrylates or methacrylates. The skilled person knows of corresponding softening temperatures. Alternatively he or she consults, for example, the Polymer Handbook [J. Brandrup, E. H. Immergut, E. A. Grulke (eds.), Polymer Handbook, 4^{th} edn. 1999, Wiley, New York]. Polymer blocks may be constructed of copolymers.

To produce a carrier material it may be appropriate here as well to add additives and other components which improve the film-forming properties, diminish the tendency for crystalline segments to form, and/or deliberately improve or else, optionally, impair the mechanical properties.

Of further suitability as carriers are foams in web form (made of polyethylene and polyurethane, for example).

The carriers may have a multilayered architecture. Furthermore, the carriers may have outer layers, such as blocking layers, which prevent penetration of components from the adhesive into the carrier or vice versa. These outer layers may also have barrier properties, in order thus to prevent water vapor, hydrogen and/or oxygen from diffusing through them.

It is preferred if the carrier is substantially free of platinum poisons. Substantially free here denotes a mass fraction of less than 100 ppm per substance. Known platinum poisons include arsenic, phosphorus, boron, bismuth, silicon, sulfur, lead, zinc, tin, antimony, silver, copper, nickel, and iron in their elemental or ionic form.

For better anchorage of the PSAs on the carrier, the carriers may be pretreated by the known measures such as corona, plasma or flame. The use of a primer is possible as well. Ideally, however, it is possible to do without any pretreatment. The reverse of the carrier may have undergone an antiadhesive physical treatment or coating.

The thickness of the carrier layer, if present, is customarily in the range from 10 to 200 μm, preferably between 20 and 100 μm.

The stress of the carrier at 50% elongation in the longitudinal direction and/or the transverse direction, especially in the longitudinal direction and the transverse direction, ought preferably to be less than 20 N/mm², more preferably less than 10 N/mm², in order to permit easy detachment of the adhesive strip without excessive application of force.

The PSAs may be produced and processed either from solution or from the melt. Application of the PSAs to the carrier layer may take place by direct coating or by lamination, especially hot lamination.

The preferably single-layer adhesive strip preferably has a thickness of 20 μm to 2000 μm, more preferably of 30 to 1000 μm, very preferably of 50 to 600 μm, such as, for example, about 250 μm. Also preferred is an embodiment of the adhesive strip wherein the carrier has a thickness of between 20 and 200 μm, preferably between 100 μm and 200 μm, and the preferably identical PSA layers disposed on the two surfaces of the carrier each have a thickness of between 20 and 200 μm, preferably between 20 μm and 50 μm. The combination of a carrier having a thickness of more than 100 μm with PSA layers having thicknesses of less than 50 μm is particularly advantageous. When water vapor barrier or hydrogen barrier materials are selected for the carrier, it is possible in this case to achieve a particularly high barrier fraction in the cross-sectional area of the adhesive strip.

The adhesive strips as described above are inventively employed for the bonding of components in an electrochemical cell or in a stack of at least two electrochemical cells, to one another.

As already explained above, the electrochemical cell is preferably a fuel cell, more preferably a fuel cell with solid electrolyte membrane, and more particularly a fuel cell with polymer electrolyte membrane, and, accordingly, the stack of electrochemical cells preferably comprises a stack of fuel cells, more preferably of fuel cells with solid electrolyte membrane, and more particularly of fuel cells with polymer electrolyte membrane. An inventive stack of electrochemical cells comprises preferably at least 10, more preferably at least 20, even more preferably at least 50, and more particularly at least 100 electrochemical cells.

If such adhesive strips are used for bonding components in an electrochemical cell or stack of electrochemical cells, then components bonded to one another by means of the adhesive strip in the electrochemical cell or in the stack of electrochemical cells are preferably as follows:
(a) bipolar half-plates,
(b) (i) membrane-electrode assemblies and (ii) bipolar plates or bipolar half-plates,
(c) (i) current collector plates and (ii) bipolar plates or bipolar half-plates, and/or
(d) (i) current collector plates and (ii) insulating plates or media distributor plates.

A media distributor plate in accordance with the invention refers to a plate via which the media are supplied—in particular, combustion gases, as for example hydrogen and oxygen. In an electrochemical cell or stack of electrochemical cells, the insulating plate and the media distributor plate may represent one and the same plate, in which case the plate in question is both insulating and media-distributing. Alternatively, the insulating plate and the media distributor plate may be present alongside one another in the cell or in the stack, therefore representing separate plates. In the latter case, the insulating plate may be adjacent to the current collector plate, followed by the media distributor plate. Alternatively, the media distributor plate may be adjacent to the current collector plate, followed by the insulating plate.

In an inventive stack of electrochemical cells, the electrochemical cells preferably finish on both sides with a respective bipolar half-plate. In this case, the bipolar half-plates of the electrochemical cells are preferably each bonded by means of an adhesive strip as defined above to the bipolar half-plates of the adjacent electrochemical cells in the stack. This enables convenient replacement of defective electrochemical cells within the stack.

In one embodiment of the inventive electrochemical cell, (i) the membrane-electrode assembly is bonded by means of in each case one adhesive strip as defined above to (ii) the two adjacent bipolar half-plates or bipolar plates. This enables the convenient replacement of a defective membrane-electrode assembly within an electrochemical cell. In a corresponding embodiment of the inventive stack of electrochemical cells, (i) the membrane-electrode assemblies of the cells are each bonded by means of an adhesive strip as defined above to (ii) the two respectively adjacent bipolar half-plates or bipolar plates. This enables, correspondingly, the convenient replacement of defective membrane-electrode assemblies within a stack of electrochemical cells.

Worded more generally, in an inventive electrochemical cell or in an inventive stack of electrochemical cells, according to one preferred embodiment, at least three successive components are bonded by means of an adhesive strip as defined above. Accordingly, in an inventive electrochemical cell or in an inventive stack, preferably at least one interior component is bonded to the two adjacent components by means of an adhesive strip as defined above. Consequently the corresponding interior component, if it is defective, can be conveniently replaced. The interior component may for example be the membrane-electrode assembly of an electrochemical cell or may be the current collector plates of a stack of electrochemical cells.

In a further embodiment of the electrochemical cell or of the stack of electrochemical cells, the plates at the ends are each bonded by means of an adhesive strip as defined above to the adjacent plates. This too enables convenient replacement of defective components—that is, of defective end plates.

The figures described hereinafter and also the examples described hereinafter provide further elucidation of particularly advantageous embodiments of the invention, without any intention thereby to subject the invention to unnecessary limitation.

### FIGURES

FIG. 1 shows an inventively employable three-layer adhesive strip in the form of a frame-shaped diecut (three-dimensional drawing).

FIG. 2 shows an inventively employable single-layer adhesive strip in the form of a frame-shaped diecut (three-dimensional drawing).

FIG. 3 shows a membrane-electrode assembly bonded inventively on either side to a respective bipolar half-plate (three-dimensional drawing).

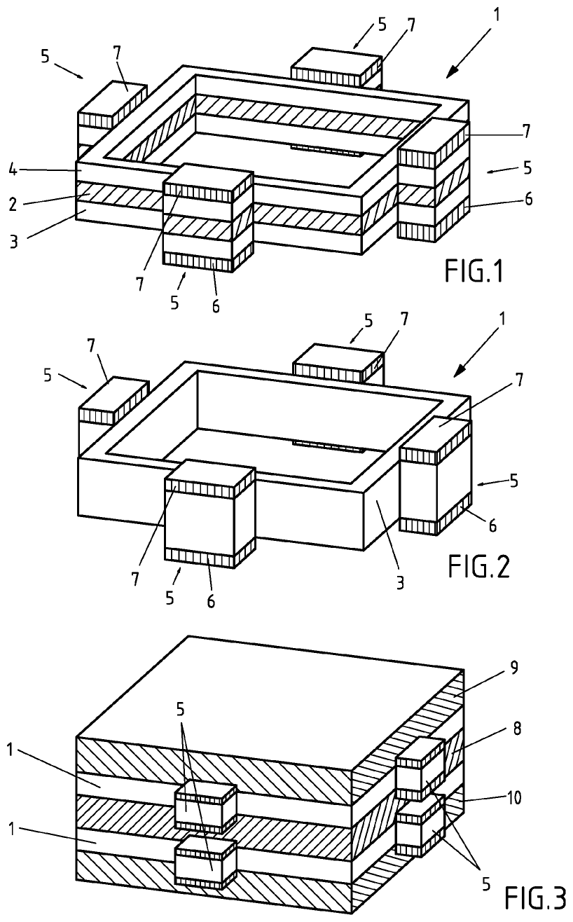

FIG. 1 shows the inventively employable adhesive strip 1, made up of three layers 2, 3, 4, which is redetachable without residue or destruction by extensive stretching substantially in the bond plane. The carrier layer 2 is of single-layer embodiment. Disposed on the carrier layer 2 on either side are layers 3, 4 of pressure sensitive adhesive (PSA), forming an outer upper and an outer lower face of the adhesive strip 1. The adhesive strip 1 is cut into a frame-shaped adhesive tape section (diecut). The adhesive strip 1, furthermore, has one projecting nonadhesive pull tab region 5 per side, starting from which the detachment operation can be performed by extensive stretching substantially in the bond zone. The pull tab regions 5 each comprise an extension of the layer sequence of the adhesive strip 1, there being disposed in the pull tab regions 5, on one outer upper and one outer lower face of the adhesive strip 1, a respective antiadhesive layer 6 and 7, preferably in the form of a double-sidedly siliconized release film 6 and 7, in order to render the pull tab regions 5 nonadhesive.

FIG. 2 shows the inventively employable adhesive strip 1, made of a single layer 3 of pressure sensitive adhesive (PSA), which is redetachable without residue or destruction by extensive stretching substantially in the bond plane. The adhesive strip 1 is cut into a frame-shaped adhesive tape section (diecut). The adhesive strip 1, furthermore, has one projecting nonadhesive pull tab region 5 per side, starting from which the detachment operation can be performed by extensive stretching substantially in the bond zone. The pull tab regions 5 each comprise an extension of the adhesive strip 1 made of a single PSA layer 3, there being disposed in the pull tab regions 5, on one outer upper and one outer lower face of the adhesive strip 1, a respective antiadhesive layer 6 and 7, preferably in the form of a double-sidedly siliconized release film 6 and 7, in order to render the pull tab regions 5 nonadhesive.

FIG. 3 shows an assembly made up of a rectangular membrane-electrode assembly 8 and two rectangular bipolar half-plates 9 and 10, where the membrane-electrode assembly 8 is bonded on its marginal reinforcement on both sides to respectively one of the bipolar half-plates 9 and 10, by means of the inventively employable single-layer adhesive strip (diecut) 1 with pull tab regions 5, as described in FIG. 2.

### EXAMPLES

An adhesive strip redetachable without residue or destruction by extensive stretching substantially in the bond plane, and consisting of a single layer of pressure sensitive adhesive based on unhydrogenated styrene block copolymer, was cut by a laser into two frame-shaped adhesive tape sections (diecuts). These diecuts were used to bond a rectangular membrane-electrode assembly on its marginal reinforcement on both sides to a respective rectangular bipolar half-plate. The design of the diecuts was such that they had a plurality of pull tab regions projecting over the ultimately bonded surfaces of the components, specifically in each case one pull tab region per bonded side, starting from which it was possible to perform the detachment operation by extensive stretching substantially in the bond zone. The pull tab regions each constituted an extension of the adhesive strip composed of a single PSA layer; disposed in the pull tab regions on one outer upper and one outer lower face of the adhesive strip was (i) in each case no antiadhesive layer (example 1 with adhesive pull tab regions) or (ii) in each case one antiadhesive layer in the form of a double-sidedly siliconized release film (example 2 with nonadhesive pull tab regions).

The component assemblies from examples 1 and 2 were subsequently each tested as follows. Testing was carried out successfully for imperviousness of the bonds, by subjecting them to 1.5 bar water pressure in the interior of the bonded plates. No water emerged. Additionally, the two bonds were readily separable by extensive stretching of the adhesive strips (in each case starting from one of the pull tab regions) substantially in the bond plane, thus allowing the membrane-electrode assembly to be conveniently replaced. In this procedure, the bipolar half-plates and the membrane-electrode assembly remained undamaged. Furthermore, there were no residues of adhesive visible on the formerly bonded surfaces of the stated components. The stated components, could therefore be bonded easily again, as before, to a respective diecut of the strippable adhesive strip, and the resultant component assembly also passed the test for imperviousness of the bonds as described above.

### Test Methods

Unless stated otherwise, all measurements were conducted at 23° C. and 50% rel. air humidity.

The mechanical and adhesive data were ascertained as follows:

### Elongation at Break, Tear Strength and Stress at 50% Elongation

Elongation at break, tear strength (tear force), and stress at 50% elongation were measured in accordance with DIN 53504 using S3-size dumbbell specimens, at a separation rate of 300 mm per minute. The test conditions were 23° C. and 50% rel. air humidity.

### Detachment Force

Detachment force (stripping force or stripping stress) was ascertained using an adhesive strip having the dimensions of length 50 mm×width 20 mm with a pull tab region which is nonadhesive at the upper end. The adhesive strip was bonded between two steel plates in a mutually congruent arrangement and having dimensions of 50 mm×30 mm with a contact pressure of 50 newtons in each case. The steel plates each have a hole to accommodate an S-shaped steel hook at their lower end. The lower end of the steel hook bears a further steel plate, by means of which the test arrangement can be fixed for measurement in the lower clamping jaw of a tensile tester. The bonds were stored at +40° C. for a period of 24 hours. After reconditioning to room temperature, the adhesive strip was detached at a strain rate of 1000 mm per minute parallel to the plane of the bond and in a contact-free manner with respect to the edge regions of the two steel plates. At the same time, the requisite detachment force in newtons (N) was measured. What is reported is the average of the stripping stress values (in N per mm²), measured in the region in which the adhesive strip has detached from the steel substrates over a bond length of between 10 mm and 40 mm.

### Peel Adhesion

The determination of peel adhesion (according to AFERA 5001) was conducted as follows. The defined substrate used was galvanized steel sheet having a thickness of 2 mm (sourced from Rocholl GmbH). The adhesive strip to be examined was cut to a width of 20 mm and a length of about 25 cm, provided with a handling section and, immediately thereafter, pressed onto the chosen substrate five times with a 4 kg steel roller at an advance rate of 10 m/min. Immediately thereafter, the adhesive strip was pulled away from the substrate at an angle of 180° with a tensile tester (from Zwick) at a velocity v=300 mm/min, and the force required for the purpose at room temperature was measured. The measured value (in N/cm) is obtained as the average value from three individual measurements.

### DACP

5.0 g of test substance (the tackifier resin sample to be examined) are weighed into a dry test tube, and 5.0 g of xylene (isomer mixture, CAS [1330-20-7], 98.5%, Sigma-Aldrich #320579 or comparable) are added. The test substance is dissolved at 130° C. and then cooled down to 80° C. Any xylene that escapes is made up for with fresh xylene, such that 5.0 g of xylene are present again. Subsequently, 5.0 g of diacetone alcohol (4-hydroxy-4-methyl-2-pentanone, CAS [123-42-2], 99%, Aldrich # H41544 or comparable) are added. The test tube is shaken until the test substance has dissolved completely. For this purpose, the solution is heated to 100° C. The test tube containing the resin solution is then introduced into a Novomatics Chemotronic Cool cloud point measuring instrument and heated therein to 110° C. It is cooled down at a cooling rate of 1.0 K/min. The cloud point is detected optically. For this purpose, that temperature at which the turbidity of the solution is 70% is registered. The result is reported in ° C. The lower the DACP, the higher the polarity of the test substance.

### MMAP

5.0 g of test substance (the tackifier resin sample under investigation) are weighed into a dry test tube and 10 ml of dry aniline (CAS [62-53-3], ≥99.5%, Sigma-Aldrich #51788 or comparable) and 5 ml of dry methylcyclohexane (CAS [108-87-2], ≥99%, Sigma-Aldrich #300306 or comparable) are added. The test tube is shaken until the test substance has dissolved completely. For this purpose, the solution is heated to 100° C. The test tube containing the resin solution is then introduced into a Novomatics Chemotronic Cool cloud point measuring instrument and heated therein to 110° C. It is cooled down at a cooling rate of 1.0 K/min. The cloud point is detected visually. For this purpose, that temperature at which the turbidity of the solution is 70% is registered. The result is reported in ° C. The lower the MMAP, the higher the aromaticity of the test substance.

### Softening Temperature

The softening temperature, especially resin softening temperature, is carried out in accordance with the relevant methodology, which is known as ring & ball and is standardized according to ASTM E28.

The determination uses an HRB 754 automated ring & ball tester from Herzog. Specimens, especially resin specimens, are first finely mortared. The resulting powder is introduced into a brass cylinder with a base aperture (internal diameter at the top part of the cylinder 20 mm, diameter of the base aperture in the cylinder 16 mm, cylinder height 6 mm) and melted on a hotplate. The amount introduced is chosen such that the specimen under test, after melting, fully fills the cylinder without protruding.

The resulting sample body, complete with cylinder, is inserted into the sample mount of the HRB 754. Glycerol or water is typically used to fill the heating bath. The test balls have a diameter of 9.5 mm and weigh 3.5 g. In line with the HRB 754 procedure, the ball is arranged above the sample body in the heating bath and is placed down on the sample body. Located 25 mm below the base of the cylinder is a catch plate, with a light barrier 2 mm above it. During the measuring procedure, the temperature is raised at 5° C./min. Within the temperature range of the softening temperature, the ball begins to move through the base aperture in the cylinder until eventually it comes to rest on the catch plate. In this position, it is detected by the light barrier, and the temperature of the heating bath at this point in time is registered. A duplicate determination takes place. The softening temperature is the average value from the two individual measurements.

### Glass Transition Temperature (T_{g})

Glass transition points—referred to synonymously as glass transition temperatures—are reported as the result of measurements by means of differential scanning calorimetry (DSC) according to DIN 53 765, especially sections 7.1 and 8.1, but with uniform heating and cooling rates of 10 K/min in all heating and cooling steps (cf. DIN 53 765; section 7.1; note 1). The sample weight is 20 mg.

### Thickness

The thickness of a PSA layer or an adhesive strip can be determined by determining the thickness of a section, defined in terms of its length and width, of such a layer or strip applied to a carrier, minus the (known or separately determinable) thickness of a section of the same dimensions of the carrier used. The thickness of the PSA layer or the adhesive strip can be determined using commercial thickness measuring instruments (caliper test instruments) with accuracies of less than 1 μm deviation. If variations in thickness are found, the average of measurements at at least three representative sites is reported, i.e., more particularly not measured at creases, folds, specks, and the like.

As already in the case of the thickness of a PSA layer or of an adhesive strip, the thickness of a carrier can also be determined using commercial thickness measuring instruments (caliper test instruments) with accuracies of less than 1 μm deviation. If variations in thickness are found, the average of measurements at at least three representative sites is reported, i.e., more particularly not measured at creases, folds, specks, and the like.

### Density

The density of a carrier is ascertained by forming the quotient of mass and thickness of the carrier. For this purpose, the mass of a section, defined in terms of its length and width, of the carrier is determined. Furthermore, the thickness of the carrier having the same dimensions is ascertained by means of a commercial thickness measuring instrument (caliper test instrument) with an accuracy of less than 1 μm deviation. If variations in thickness are found, the average of measurements at at least three representative sites is reported, i.e., more particularly not measured at creases, folds, specks, and the like.

1. An electrochemical cell or stack of at least two electrochemical cells, comprising at least two components of the electrochemical cell or of the stack of electrochemical cells bonded to one another by means of an adhesive strip which is redetachable by extensive stretching substantially in the bond plane, the adhesive strip comprising one or more layers of pressure sensitive adhesive and optionally one or more carrier layers, and one outer upper and one outer lower face of the adhesive strip being formed by the layer or layers of pressure sensitive adhesive.

2. The electrochemical cell or stack of electrochemical cells as claimed in claim 1, wherein the adhesive strip is redetachable without residue or destruction by extensive stretching substantially in the bond plane.

3. The electrochemical cell or stack of electrochemical cells as claimed in claim 1, wherein the adhesive strip consists of a single layer of pressure sensitive adhesive.

4. The electrochemical cell or stack of electrochemical cells as claimed in claim 1, wherein the adhesive strip comprises a carrier layer and two layers of pressure sensitive adhesive, the two layers of pressure sensitive adhesive being disposed on the opposite surfaces of the carrier layer and forming one outer upper and one outer lower face of the adhesive strip.

5. The electrochemical cell or stack of electrochemical cells as claimed in claim 1, wherein the adhesive strip comprises at least one layer of pressure sensitive adhesive based on vinylaromatic block copolymer.

6. The electrochemical cell or stack of electrochemical cells as claimed in claim 5, wherein the vinylaromatic block copolymers comprise polymer blocks (i) predominantly formed of vinylaromatics (A blocks) and at the same time (ii) blocks predominantly formed by polymerization of 1,3-dienes (B blocks) or of butylenes (B blocks).

7. The electrochemical cell or stack of electrochemical cells as claimed in claim 5, wherein the at least one layer of pressure sensitive adhesive is constructed on the basis of vinylaromatic block copolymer and tackifier resin, a tackifier resin having a DACP of greater than 30° C., having an MMAP of greater than 50° C., and/or having a softening temperature of greater than 95° C.

8. The electrochemical cell or stack of electrochemical cells as claimed in claim 1, wherein the adhesive strip comprises at least one layer of pressure sensitive adhesive based on at least one block copolymer which is constructed at least partially of (meth)acrylic derivatives, the block copolymer comprising at least the unit P(A)-P(B)-P(A) composed of at least one polymer block P(B) and at least two polymer blocks P(A), and
P(A) independently of one another representing homopolymer or copolymer blocks of monomers A, the polymer blocks P(A) each having a softening temperature in the range from +20° C. to +175° C.,
P(B) representing a homopolymer or copolymer block of monomers B, the polymer block P(B) having a softening temperature in the range from −100° C. to +10° C., and
the polymer blocks P(A) and P(B) being not homogeneously miscible with one another.

9. The electrochemical cell or stack of electrochemical cells as claimed in claim 1, wherein the adhesive strip comprises at least one layer of pressure sensitive adhesive based on polyisobutylene homopolymer and/or polyisobutylene copolymer.

10. The electrochemical cell or stack of electrochemical cells as claimed in claim 1, wherein the adhesive strip comprises at least one layer of pressure sensitive adhesive based on solid acrylonitrile-butadiene rubber and further comprising tackifier resin, the fraction of tackifier resin being in total 30 to 130 phr.

11. The electrochemical cell or stack of electrochemical cells as claimed in claim 1, wherein the adhesive strip comprises at least one layer of pressure sensitive adhesive which is crosslinked.

12. The electrochemical cell or stack of electrochemical cells as claimed in claim 1, wherein the adhesive strip comprises at least one layer of pressure sensitive adhesive in which there is modified silica.

13. The electrochemical cell or stack of electrochemical cells as claimed in claim 1, wherein the adhesive strip comprises at least one layer of pressure sensitive adhesive which comprises endblock reinforcer resin.

14. The electrochemical cell or stack of electrochemical cells as claimed in claim 1, wherein the carrier layer of the adhesive strip, if present, has an elongation at break in the longitudinal direction and/or the transverse direction of at least 100%.

15. The electrochemical cell or stack of electrochemical cells as claimed in claim 1, wherein the carrier layer of the adhesive strip, if present, is made of polyethylene having a density of 0.94 g/cm³ or less.

16. The electrochemical cell or stack of electrochemical cells as claimed in claim 1, wherein the one or more layers of pressure sensitive adhesive and, if present, the one or more carrier layers are substantially free from platinum poisons.

17. The electrochemical cell or stack of electrochemical cells as claimed in claim 1, wherein the adhesive strip is embodied such that the at least two components of the electrochemical cell or of the stack of electrochemical cells are bonded to one another over the full area by means of the adhesive strip.

18. The electrochemical cell or stack of electrochemical cells as claimed in claim 1, wherein the adhesive strip is embodied such that the at least two components of the electrochemical cell or of the stack of electrochemical cells are bonded to one another over part of the area by means of the adhesive strip.

19. The electrochemical cell or stack of electrochemical cells as claimed in claim 1, wherein the adhesive strip is embodied such that it has at least one nonadhesive pull tab region, starting from which the detachment operation can be implemented by extensive stretching, said region projecting beyond those surfaces of the at least two components that are to be bonded.

20. The electrochemical cell or stack of electrochemical cells as claimed in claim 19, wherein the pull tab region of the adhesive strip is not adhesive.

21. The electrochemical cell or stack of electrochemical cells as claimed in claim 1, wherein the electrochemical cell is a fuel cell or the stack of electrochemical cells is a stack of fuel cells.

22. The electrochemical cell or stack of electrochemical cells as claimed in claim 1, wherein in the electrochemical cell or in the stack of electrochemical cells, the following components are bonded to one another by means of the adhesive strip:
(a) bipolar half-plates,
(b) (i) membrane-electrode assemblies and (ii) bipolar plates or bipolar half-plates,
(c) (i) current collector plates and (ii) bipolar plates or bipolar half-plates, and/or
(d) (i) current collector plates and (ii) insulating plates or media distributor plates.

23. A method for bonding with the adhesive strip as claimed in claim 1 components in an electrochemical cell or in a stack of at least two electrochemical cells to one another, wherein the electrochemical cell is a fuel cell or wherein the stack of electrochemical cells is a stack of fuel cells.

24. The method as claimed in claim 23, wherein the electrochemical cell or the stack of electrochemical cells is operated after bonding and subsequently the adhesive strip is redetached by extensive stretching substantially in the bond plane.

25. The method of an adhesive strip as claimed in claim 1 for bonding components in an electrochemical cell or in a stack of at least two electrochemical cells to one another in order to obtain more particularly residue-free and destruction-free redetachability of the adhesive strip by extensive stretching of the adhesive strip substantially in the bond plane, wherein the electrochemical cell is a fuel cell or wherein the stack of electrochemical cells is a stack of fuel cells.

26. The method as claimed in any of claim 23, wherein in the electrochemical cell or in the stack of electrochemical cells, the following components are bonded to one another by means of the adhesive strip:
(a) bipolar half-plates,
(b) (i) membrane-electrode assemblies and (ii) bipolar plates or bipolar half-plates,
(c) (i) current collector plates and (ii) bipolar plates or bipolar half-plates, and/or
(d) (i) current collector plates and (ii) insulating plates or media distributor plates.

27. The method as claimed in claim 23, wherein the adhesive strip is embodied such that the components of the electrochemical cell or of the stack of electrochemical cells are bonded to one another over the full area or bonded to one another over part of the area, by means of the adhesive strip.

28. The method as claimed in claim 23, wherein the adhesive strip is embodied such that it has at least one nonadhesive pull tab region, starting from which the detachment operation can be implemented by extensive stretching, said region projecting beyond those surfaces of the components that are to be bonded, wherein the pull tab region.
